(19) United States
(12) Patent Application Publication
(10) Pub. No.: US 2009/0322878 A1
(43) Pub. Date: Dec. 31, 2009

(54) Image Processor, Image Processing Method, And Vehicle Including Image Processor

(75) Inventor: Yohei Ishii, Osaka City (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Moriguchi City (JP)

(21) Appl. No.: 12/107,286

(22) Filed: Apr. 22, 2008

(30) Foreign Application Priority Data
Apr. 23, 2007 (JP) JP2007-113079

(51) Int. Cl. H04N 7/18; H04N 5/228

(52) U.S. Cl. 348/148; 348/222.1; 348/E05.024

(57) ABSTRACT

A visibility support system is provided which displays a wide field of view while absorbing camera installation errors. The visibility support system obtains a first conversion matrix H₁ for projecting a captured image onto the ground, while a second conversion matrix H₂ for projecting the captured image on a plane different from the ground (e.g. no-conversion unit matrix) is set. An extended high-angle view image is divided into a first region corresponding to the vehicle periphery and a second region corresponding to farther away from the vehicle, and a high-angle view image based on H₁ is displayed in the first region, whereas an image based on a weight-added conversion matrix in which H₁ and H₂ are weight-added is displayed in the second region. Weight for the weight-addition is varied according to a distance from the border of the first and second regions to seamlessly join the images in both regions.

### CROSS REFERENCE TO RELATED APPLICATIONS

This application claims priority under 35 USC 119 from prior Japanese Patent Application No. P2007-113079 filed on Apr. 23, 2007, the entire contents of which are incorporated herein by reference.

### BACKGROUND OF THE INVENTION

1. Field of the Invention

This invention relates generally to image processing of camera images, and more particularly to vehicle peripheral visibility support technology that generates and displays an image similar to a high-angle view image by processing a captured image of an on-vehicle camera. This invention also relates to a vehicle utilizing such an image processor.

2. Description of Related Art

With the increased safety awareness of recent years, it is becoming more common to mount a camera on a vehicle such as a car. Also, instead of simply displaying the captured image, research has been made to provide more user-friendly images by utilizing image processing technology. One such technology converts a captured image of an obliquely installed camera to an image viewed from above by a coordinate conversion or an image conversion. See e.g. Japanese Patent Application Laid-Open No. 3-99952. Such an image generally is called a bird's eye view image or a high-angle view image.

Techniques to perform such a coordinate conversion are generally known, such as perspective projection transformation (see, e.g. Japanese Patent Application Laid-Open No. 2006-287892) and planar projective transformation (see, e.g. Japanese Patent Application Laid-Open No. 2006-148745).

In the perspective projection transformation, transformation parameters are computed to project a captured image onto a predetermined plane (such as a road surface) based on external information of a camera such as a mounting angle of the camera and an installation height of the camera, and internal information of the camera such as a focal distance (or a field angle) of the camera. Therefore, it is necessary to accurately determine the external information of the camera in order to perform coordinate transformations with high accuracy. While the mounting angle of the camera and the installation height of the camera are often designed beforehand, errors may occur between such designed values and the actual values when a camera is installed on a vehicle, and therefore, it is often difficult to measure or estimate accurate transformation parameters. Thus, the coordinate conversion based on the perspective projection transformation is susceptible to installation errors of the camera.

In the planar projective transformation, a calibration pattern is placed within an image-capturing region, and based on the captured calibration pattern, the calibration procedure is performed by obtaining a conversion matrix that indicates a correspondence relationship between coordinates of the captured image (two-dimensional camera coordinates) and coordinates of the converted image (two-dimensional world coordinates). This conversion matrix is generally called a homography matrix. The planar projective transformation does not require external or internal information of the camera, and the corresponding coordinates are specified between the captured image and the converted image based on the calibration pattern that was actually captured by a camera, and therefore, the planar projective transformation is not affected by camera installation errors, or is less susceptible to camera installation errors.

Displaying a high-angle view image obtained by the perspective projection transformation or the planar projective transformation makes it easier for a driver to gauge the distance between the vehicle and obstacles. However, the high-angle view image is not suitable to draw far away images from the vehicle by its nature. That is, in a system that simply displays a high-angle view, there is a problem that it is difficult to display images captured by the camera that are of objects distant from the vehicle.

To address this problem, a technique is proposed in which a high-angle view image is displayed within an image region corresponding to the vehicle periphery, while a far-away image is displayed within an image region corresponding to a distance farther away from the vehicle. Such a technique is described e.g. in Japanese Patent Application Laid-Open No. 2006-287892. Japanese Patent Application Laid-Open No. 2006-287892 also describes a technique to join both of the image regions seamlessly. According to this technique, it is possible to support the distant field of view from the vehicle while making it easy for a driver to gauge the distance between the vehicle and obstacles by the high-angle view image. Therefore, it can improve visibility over a wide region.

However, the perspective projection transformation is necessary in order to achieve the technique described in Japanese Patent Application Laid-Open No. 2006-287892, which makes it susceptible to camera installation errors. Although the planar projective transformation can absorb camera installation errors, the technique described in Japanese Patent Application Laid-Open No. 2006-287892 cannot be achieved by using the planar projective transformation.

### SUMMARY OF THE INVENTION

This invention was made in view of the above problems, and one object of this invention, therefore, is to provide an image processor and an image processing method that can achieve image processing that is less susceptible to camera installation errors while assuring an image display that encompasses a wide region, and to provide a vehicle utilizing such an image processor.

In order to achieve the above objects, one aspect of the invention provides an image processor that generates a converted image from a captured image of a camera based on a plurality of conversion parameters including a first conversion parameter for projecting the captured image on a predetermined first plane and a second conversion parameter for projecting the captured image on a predetermined second plane, the second plane being different from the first plane, in which the image processor includes a conversion image generating unit that generates the converted image by dividing the converted image into a plurality of regions including a first region and a second region, and generating an image within the first region based on the first conversion parameter, and generating an image within the second region based on a weight-added conversion parameter obtained by weight-adding the first conversion parameter and the second conversion parameter.

By appropriately setting the first and second planes, it becomes possible to depict a wide field of view on the converted image. With the above configuration, it becomes possible to derive the first and/or the second parameters based on the planar projective transformation. Thus, it is less susceptible to the camera installation errors. Moreover, by generating the image within the second region using the weight-added conversion parameter, it is possible to join the images of the first and second regions seamlessly.

More specifically, for example, an object closer to an installation position of the camera appears in the image within the first region and an object farther away from the installation position appears in an image within the second region.

Moreover, the weight of the weight-addition corresponding to each point within the second region is set based on a distance from the border of the first and second regions to the each point. Thus, it becomes possible to join the images of the first and second regions seamlessly. In particular, for example, the weight is set such that a degree of contribution of the second conversion parameter to the weight-added conversion parameter increases as the distance increases.

Also, the camera may be installed on a vehicle and the first plane may be the ground on which the vehicle is placed. The conversion image generating unit converts a part of the captured image of the camera to a high-angle view image viewed from a virtual observation point above the vehicle based on the first conversion parameter, and includes the high-angle view image as an image within the first region.

Another aspect of the invention provides a vehicle having the camera and the image processor described above.

Still another aspect of the invention provides an image processing method for converting an image from a camera based on a plurality of conversion parameters including a first conversion parameter for projecting the captured image on a predetermined first plane and a second conversion parameter for projecting the captured image on a predetermined second plane, the second plane being different from the first plane. The method includes dividing the converted image into a plurality of regions including a first region and a second region; generating an image within the first region based on the first conversion parameter; and generating an image within the second region based on a weight-added conversion parameter obtained by weight-adding the first conversion parameter and the second conversion parameter.

### BRIEF DESCRIPTION OF THE DRAWINGS

FIGS. 1A and 1B respectively are a top plan view and side view of a vehicle on which a camera is installed according to one embodiment of the invention;

FIG. 2 is a block diagram of the configuration of a visibility support system according to one embodiment of the invention;

FIG. 3 is a flow chart showing an overall operation procedure of the visibility support system of FIG. 2;

FIG. 4A is a top plan view of a calibration plate used at the time of performing calibration on the visibility support system of FIG. 2;

FIG. 4B is a top plan view showing a placement relation between the calibration plate and the vehicle at the time of performing the calibration;

FIG. 5 is a figure showing a relation between a captured image of the camera of FIG. 1 and a conventional high-angle view image obtained from the captured image;

FIG. 6 is a figure showing a plane on which the captured image of the camera of FIG. 1 is projected;

FIG. 7 is a figure showing an extended high-angle view image generated by the image processor of FIG. 2;

FIG. 8 is a figure for explaining a distance in the backward of the vehicle of FIG. 1;

FIG. 9 is a figure showing a conversion relation between a captured image of the camera of FIG. 2 and an extended high-angle view image;

FIG. 10 is a figure showing a conversion matrix corresponding to each horizontal line of the extended high-angle view image of FIG. 7;

FIG. 11 is a figure showing a conversion relation between a captured image of the camera of FIG. 2 and the extended high-angle view image;

FIG. 12 is a figure showing a captured image of the camera of FIG. 2 and an extended high-angle view image obtained from the captured image;

FIG. 13 is a figure for explaining a camera installation state relative to the vehicle of FIG. 1; and

FIGS. 14A and 14B are figures showing examples for region segmentation for a converted image generated from a captured image of the camera utilizing weight-addition of a plurality of conversion matrices.

### DETAILED DESCRIPTION OF EMBODIMENTS

Preferred embodiments of the invention will be described below with reference to the accompanying drawings. The same reference numbers are assigned to the same parts in each of the drawings being referred to, and overlapping explanations for the same parts are omitted in principle.

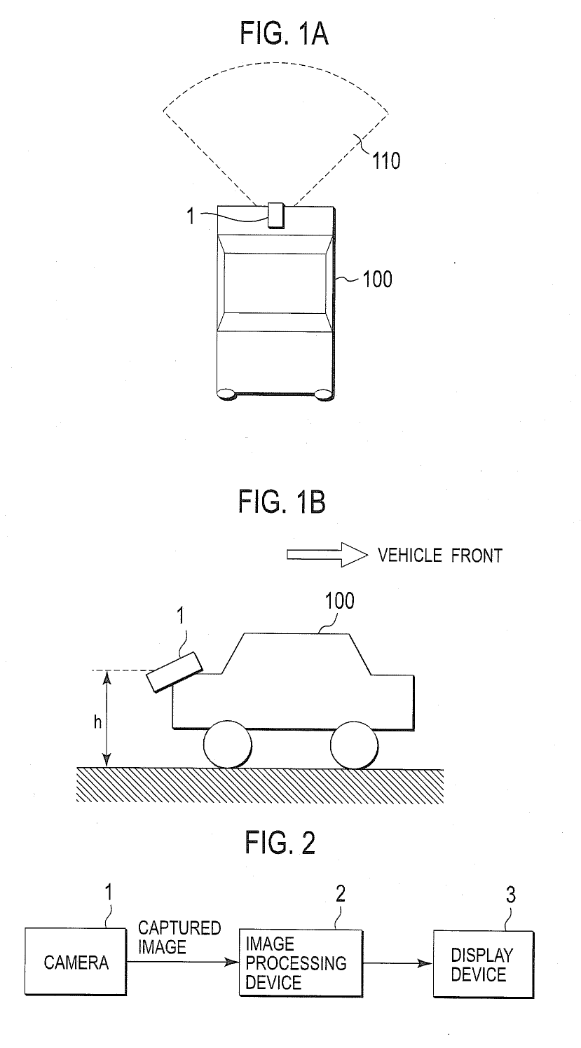

FIG. 1A is a top plan view of a vehicle 100, such as a car. FIG. 1B is a side view of the vehicle 100. The vehicle 100 is positioned on the ground. A camera 1 is installed at the rear of the vehicle 100 for supporting visual safety confirmation of the vehicle when moving backward. The camera 1 is installed such that it has a field of view of the area rearward of the vehicle 100. The fan-shaped area 110 of the dotted-line shows an image-capturing region of the camera 1. The camera 1 is installed to be directed downward such that the ground near the rear of the vehicle 100 is included in the field of view of the camera 1. While a regular passenger car is illustrated for the vehicle 100 by an example, the vehicle 100 can be any other vehicle such as a truck, bus, tractor-trailer etc.

In the following explanation, the ground is illustrated as being on the horizontal plane and a “height” indicates the height from the ground. The reference symbol h as shown in FIG. 1B indicates the height of the camera 1 (i.e. the height of the point at which the camera 1 is installed).

FIG. 2 shows a block diagram of the configuration of a visibility support system according to one embodiment of the invention. The camera 1 captures an image and sends signals representing the captured image to an image processing device 2. The image processing device 2 generates an extended high-angle view image from the captured image, although the captured image undergoes image processing such as distortion correction before being converted to the extended high-angle view image. A display device 3 displays the extended high-angle view image as a video picture.

The extended high-angle view image according to the embodiment differs from a conventional high-angle view image. While it will be described in more detail below, generally speaking, the extended high-angle view image of the embodiment is an image generated such that a regular high-angle view image is depicted in a region relatively close to the vehicle 100, whereas an image similar to the original image (the captured image itself) is depicted in a region relatively far away from the vehicle 100. In this embodiment, a “regular high-angle view image” and a “high-angle view image” have the same meaning.

The high-angle view image is a converted image in which the actual captured image of the camera 1 is viewed from an observation point of a virtual camera (virtual observation point). More specifically, the high-angle view image is a converted image in which an actual captured image of the camera 1 is converted to an image of the ground plane observed from above in the vertical direction. The image conversion of this type is generally also called an observation point conversion.

For example, cameras using CCD (Charge Coupled Devices) or CMOS (Complementary Metal Oxide Semiconductor) image sensors may be used as the camera 1. The image processing device 2 for example can be an integrated circuit. The display device 3 can be a liquid crystal display panel. A display device included in a car navigation system also can be used as the display device 3 of the visibility support system. Also, the image processing device 2 may be incorporated as a part of the car navigation system. The image processing device 2 and the display device 3 are mounted for example in the vicinity of the driver's seat of the vehicle 100.

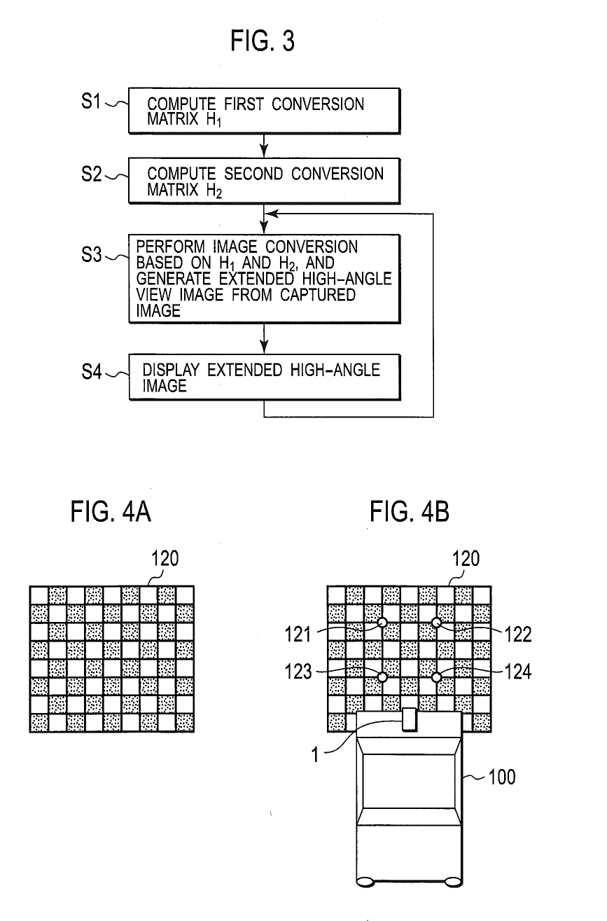

An overall operation procedure of the visibility support system of FIG. 2 will be explained by referring to FIG. 3. FIG. 3 is a flow chart showing this operation procedure.

In order to generate the extended high-angle view image, conversion parameters are needed to convert the captured image to the extended high-angle view image. Computing of these conversion parameters corresponds to the processing of steps S1 and S2. The processing of the steps S1 and S2 is implemented by the image processing device 2 based on the captured image of the camera 1 at the time of calibration of the camera 1. Operations to be implemented at the processing of the step S1 and S2 also may be implemented by an external instruction execution unit (not shown) other than the image processing device 2. In other words, first and second conversion matrices H₁ and H₂ to be hereinafter described may be computed by the external instruction execution unit based on the captured image of the camera 1, and the computed first and second conversion matrices H₁ and H₂ may then be provided to the image processing device 2.

At the step S1, the first conversion matrix H₁ is obtained for converting a captured image of the camera to a regular high-angle view image by the planar projective transformation. The planar projective transformation itself is known, and the first conversion matrix H₁ can be obtained by using the known techniques. The first conversion matrix H₁ may be indicated simply as H₁. Second and third conversion matrices H₂ and H₃ to be hereinafter described also may be indicated simply as H₂ and H₃ respectively.

A planar calibration plate 120 such as shown in FIG. 4A is prepared, and the vehicle 100 is placed such that the whole or a part of the calibration plate 120 is fitted in the image capturing area (field of view) of the camera 1 as shown in FIG. 4B. The captured image obtained by the camera 1 in this placement condition will be called a “captured image for calibration”. Also, the image obtained by coordinate-converting the captured image for calibration using the first conversion matrix H₁ will be called a “converted image for calibration”. At the step S1, the first conversion matrix H₁ is computed based on the captured image for calibration.

Grid lines are vertically and horizontally formed at even intervals on the surface of the calibration plate 120, and the image processing device 2 can extract each intersecting point of the vertical and horizontal grid lines that appears on the captured image. In the example shown in FIGS. 4A and 4B, a so-called checkered pattern is depicted on the calibration plate 120. This checkered pattern is formed with black squares and white squares that are adjacent to each other and the point at which one vertex of the black square meets one vertex of the white square corresponds to an intersecting point of the vertical and horizontal grid lines.

The image processing device 2 perceives each of the above intersecting points formed on the surface of the calibration plate 120 as feature points, extracts four independent feature points that appear in the captured image for calibration, and identifies the coordinate values of the four feature points in the captured image for calibration. An instance will be considered below in which the four intersecting points 121 to 124 in FIG. 4B are treated as the four feature points. The technique to identify the above coordinate values is arbitrary. For example, four feature points can be extracted and their coordinate values identified by the image processing device 2 using edge detection processing or positions of the four feature points can be provided externally to the image processing device 2.

Coordinates of each point on the captured image for calibration are indicated as (x_{A}, y_{A}) and coordinates of each point on the converted image for calibration as (X_{A}, Y_{A}). x_{A} and X_{A} are coordinate values in the horizontal direction of the image, and y_{A} and Y_{A} are coordinate values in the vertical direction of the image. The relationship of the coordinates (x_{A}, y_{A}) on the captured image for calibration and the coordinates (X_{A}, Y_{A}) on the converted image for calibration can be indicated as the formula (1) below using the first conversion matrix H₁. H₁ generally is called a homography matrix. The homography matrix H₁ is a 3×3 matrix and each of the elements of the matrix is expressed by h_{A1} to h_{A9}. Moreover, h_{A9}=1 (the matrix is normalized such that h_{A9}=1). From the formula (1), the relation between the coordinates (x_{A}, y_{A}) and the coordinates (X_{A}, Y_{A}) also can be expressed by the following formulas (2a) and (2b).

$$\begin{matrix}\begin{matrix}( \begin{matrix}{X}_{A} \\ {Y}_{A} \\ 1\end{matrix} ) = {H}_{1} ( \begin{matrix}{x}_{A} \\ {y}_{A} \\ 1\end{matrix} ) \\ = ( \begin{matrix}{h}_{A 1} & {h}_{A 2} & {h}_{A3} \\ {h}_{A 4} & {h}_{A 5} & {h}_{A 6} \\ {h}_{A 7} & {h}_{A 8} & {h}_{A 9}\end{matrix} ) ( \begin{matrix}{x}_{A} \\ {y}_{A} \\ 1\end{matrix} ) \\ = ( \begin{matrix}{h}_{A 1} & {h}_{A 2} & {h}_{A3} \\ {h}_{A 4} & {h}_{A 5} & {h}_{A 6} \\ {h}_{A 7} & {h}_{A 8} & 1\end{matrix} ) ( \begin{matrix}{x}_{A} \\ \begin{matrix}{y}_{A} \\ 1\end{matrix}\end{matrix} )\end{matrix} & ( 1 ) \\ {X}_{A} = \frac{{H}_{A 1} {x}_{A} + {h}_{A 2} {y}_{A} + {h}_{A 3}}{{h}_{A 7} {x}_{A} + {h}_{A 8} {y}_{A} + 1} & ( 2 a ) \\ {Y}_{A} = \frac{{H}_{A 4} {x}_{A} + {h}_{A 5} {y}_{A} + {h}_{A 6}}{{h}_{A 7} {x}_{A} + {h}_{A 8} {y}_{A} + 1} & ( 2 b )\end{matrix}$$

The coordinate values of the four feature points 121 to 124 on the captured image for calibration identified by the image processing device 2 are respectively (x_{A1}, y_{A1}), (x_{A2}, y_{A2}), (x_{A3}, y_{A3}), and (x_{A4}, y_{A4}). Also, the coordinate values of the four feature points on the converted image for calibration are set according to known information previously recognized by the image processing device 2. The four coordinate values that are set as such are (X_{A1}, Y_{A1}), (X_{A2}, Y_{A2}), (X_{A3}, Y_{A3}), and (X_{A4}, Y_{A4}). Now suppose the graphic form drawn by the four feature points 121 to 124 on the calibration pattern 120 is square. Then, since H₁ is a conversion matrix to convert the captured image of the camera 1 to the normal high-angle view image, the coordinate values (X_{A1}, Y_{A1}), (X_{A2}, Y_{A2}), (X_{A3}, Y_{A3}), and (X_{A4}, Y_{A4}) can be defined e.g. as (0, 0), (1, 0), (0, 1) and (1, 1).

The first conversion matrix H₁ can be uniquely determined once the corresponding relation of the four coordinate values is known between the captured image for calibration and the converted image for calibration. A known technique can be used to obtain the first conversion matrix H₁ as a homography matrix (projective transformation) based on the corresponding relations of the four coordinate values. For example, the method described in Japanese Patent Application Laid-Open No. 2004-342067 (specifically see paragraph numbers [0059] to [0069]) may be used. In other words, the elements h_{A1} to h_{A8} of the homography matrix H₁ are obtained such that the coordinate values (x_{A1}, y_{A1}), (X_{A2}, y_{A2}), (x_{A3}, y_{A3}), and (x_{A4}, y_{A4}) are converted to the coordinate values (X_{A1}, Y_{A1}), (X_{A2}, Y_{A2}), (X_{A3}, Y_{A3}), and (X_{A4}, Y_{A4}) respectively. In practice, the elements h_{A1}, to h_{A8} are obtained such that errors of this conversion (the set valuation function described in Japanese Patent Application Laid-Open No. 2004-342067) are minimized.

Once the first conversion matrix H₁ is obtained, it becomes possible to convert an arbitrary point on the captured image to a point on the high-angle view image. Although a particular method to obtain the matrix H₁ based on the corresponding relation of the coordinate values of the four points was explained, of course the matrix H₁ can be obtained based on the corresponding relation of the coordinate values of five or more points.

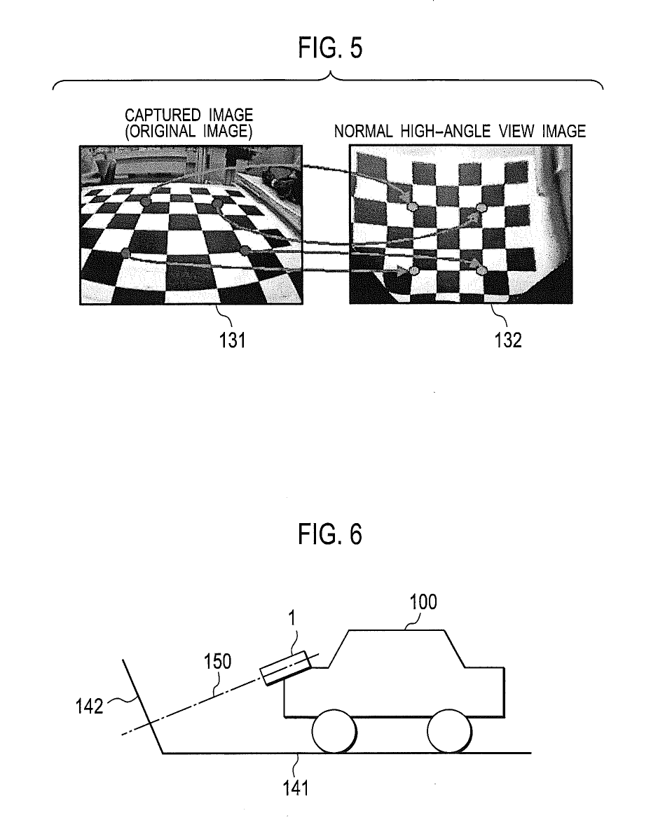

FIG. 5 shows a captured image 131 of the camera 1 and a high-angle image 132 obtained by image conversion of the captured image 131 using the matrix H₁. FIG. 5 also shows the corresponding relation of the four feature points (the feature points 121 to 124 of FIG. 4B).

After obtaining the first conversion matrix H₁ at the step S1 of FIG. 3, the second conversion matrix H₂ is obtained at the step S2. Although a specific method to derive the second conversion matrix H₂ will be described in detail below, here the difference between H₁ and H₂ is explained.

The first conversion matrix H₁ is a conversion matrix for projecting the captured image of the camera 1 on a first plane, while the second conversion matrix H₂ is a conversion matrix for projecting the captured image of the camera 1 on a second plane that is different from the first plane. In the case of this example, the first plane is the ground. FIG. 6 shows a plan view showing a relationship between the first and second planes and the vehicle 100. The plane 141 is the first plane and the plane 142 is the second plane. The second plane is an oblique plane with respect to the first plane (the ground) and it is neither parallel to nor perpendicular to the first plane. The light axis 150 of the camera 1 for example is perpendicular to the second plane. In this case, the second plane is parallel to the imaging area of the camera 1.

The high-angle view image is an image in which the actual captured image of the camera 1 is converted to an image viewed from a first observation point based on the first conversion matrix H₁, and the height of the first observation point is substantially higher than the height h of the camera 1 (FIG. 1B). On the other hand, the second conversion matrix Hₛ is a conversion matrix for converting the actual captured image of the camera 1 to an image viewed from a second observation point, and the height of the second observation point is lower than the height of the first observation point, such as the same as the height h of the camera 1. The positions of the first and second observation points in the horizontal direction are the same as the horizontal position of the camera 1.

After H₁ and H₂ are obtained by the steps S1 and S2 of FIG. 3, the process moves to the step S3 and the processing of the steps S3 and S4 are repeated. The processing of the steps S1 and S2 are implemented at the calibration stage of the camera 1, whereas the processing of the steps S3 and S4 are implemented at the time of actual operation of the visibility support system.

At the step S3, the image processing device 2 of FIG. 2 generates an extended high-angle view image for the captured image of the camera by image conversion based on H₁ and H₂ and sends picture signals indicating the extended high-angle view image to the display device 3. At the step S4 that follows the step S3, the display device 3 displays the extended high-angle view image on the display screen by outputting the picture according to the picture signals given.

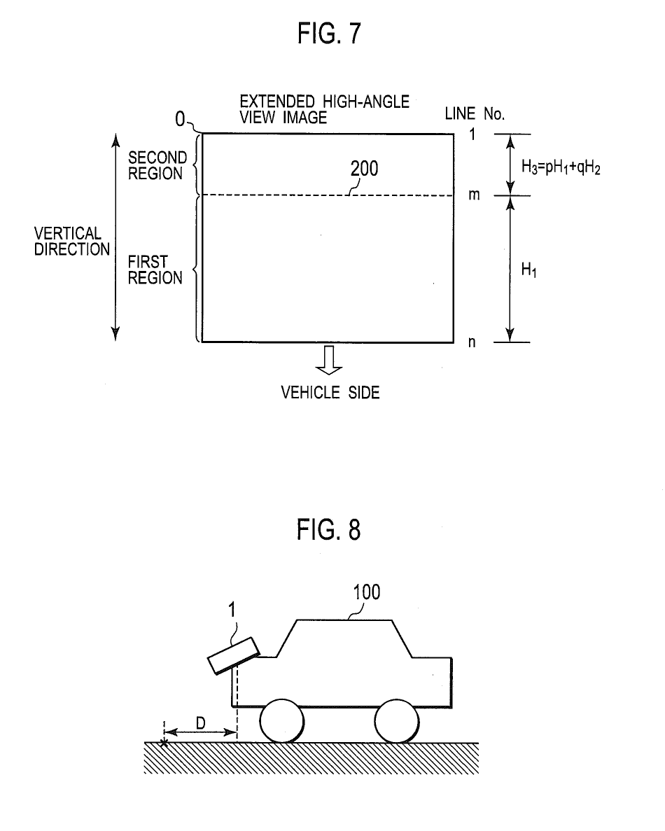

A method of generating the extended high-angle view image will now be explained in detail. As shown in FIG. 7, the extended high-angle view image is considered by segmenting the image in the vertical direction. The two regions obtained by this segmentation will be called a first region and a second region. The image in which the first and second regions are put together is the extended high-angle view image. In FIG. 7, the dotted line 200 indicates a border between the first and second regions.

The point of origin for the extended high-angle view image is shown as O. In the extended high-angle view image, a horizontal line including the origin point O is set as a first horizontal line. The extended high-angle view image is formed by each pixel on the first to the n^{th} horizontal lines. The first horizontal line is positioned at the upper end of the extended high-angle view image, and the n^{th} horizontal line is positioned at the lower end. In the extended high-angle view image, the first, second, third, . . . , the (m−1)^{th}, the m^{th}, the (m+1)^{th}, . . . the (n−1)^{th}, and the n^{th} lines are arranged from the first horizontal line to the n^{th} horizontal line. Here, m and n are integers over 2, and m<n. For example, m=120 and n=480.

The image within the second region is formed by each pixel on the 1^{st} to the m^{th} horizontal lines, and the image within the first region is formed by each pixel on the (m+1)^{th} to the n^{th} horizontal lines. The extended high-angle view image is generated such that an object positioned closer to the vehicle 100 appears in the lower side of the extended high-angle view image. In other words, when setting the intersecting point of the vertical line passing through the center of the image pickup device of the camera 1 and the ground as a reference point, and setting a distance from the reference point in the rearward direction from the vehicle 100 as D, as shown in FIG. 8, the extended high-angle view image is generated such that a point on the ground having the distance D=D₁ appears on the k₁th horizontal line, and a point on the ground having the distance D=D₂ appears on the k₂th horizontal line. Here, D₁<D₂ and k₁>k₂.

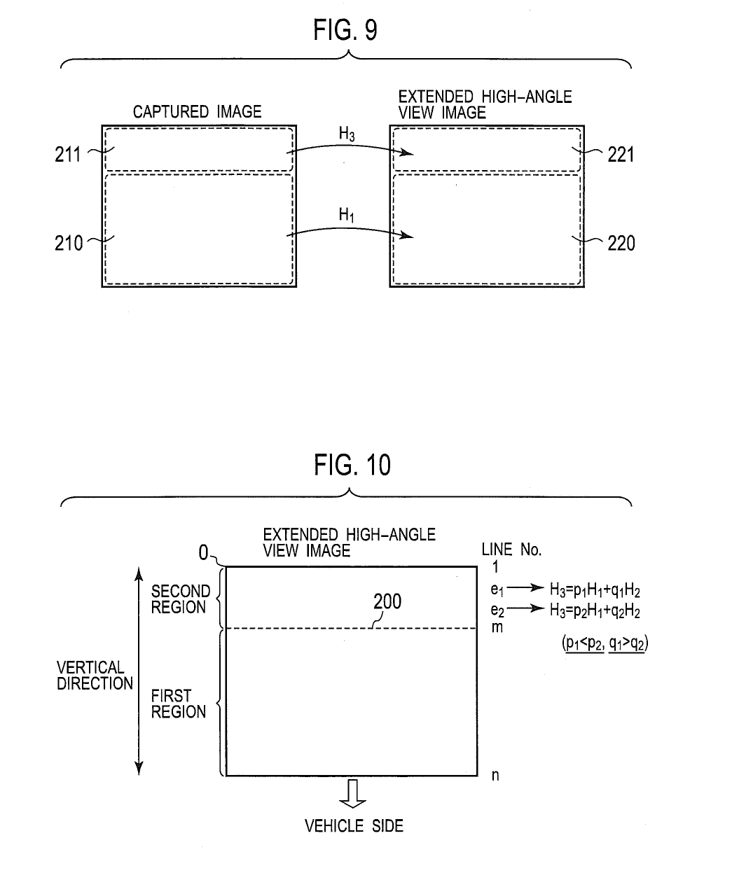

FIG. 9 shows a relation between the captured image and the extended high-angle view image. As shown in FIG. 9, an image obtained by coordinate conversion of the image within a partial region 210 of the captured image using the first conversion matrix H₁ becomes an image within the first region 220 of the extended high-angle view image, and an image obtained by coordinate conversion of the image within the partial region 211 of the captured image using the weight-added conversion matrix H₃ becomes an image within the second region 221 of the extended high-angle view image. The partial region 210 and the partial region 211 do not overlap with each other, and an object in the periphery of the vehicle 100 appears within the partial region 210, while an object farther away from the vehicle 100 appears within the partial region 211.

The weight-added conversion matrix H₃ is obtained by weight-adding (weighting addition) the first conversion matrix H₁ and the second conversion matrix H₂. Thus, H₃ can be indicated by the formula (3) below.

H₃=pH₁+qH₂ (3)

The above p and q are weighting factors in the weighting addition. Constantly, q=1−p and 0<p<1 are true. The values for p and q are changed based on the distance from the border 200 (FIG. 7) such that the converted image by H₁ and the converted image by H₂ are connected seamlessly. Here, the distance from the border 200 indicates the distance in the direction of from the n^{th} horizontal line to the 1^{st} horizontal line on the extended high-angle view image.

More specifically, as the distance from the border 200 increases, a degree of contribution of H₂ toward H₃ is increased by increasing the value q, and as the distance from the border 200 decreases, a degree of contribution of H₁ toward H₃ is increased by increasing the value of p. That is, as shown in FIG. 10, the values for p and q are determined such that they satisfy p₁<p₂ and q₁>q₂ when e₁<e₂<m; and when H₃ for the e₁^{th} horizontal line is indicated as H₃=p₁H₁+q₁H₂; and H₃ for the e₂^{th} horizontal line is indicated as H₃=p₂H₁+q₂H₂.

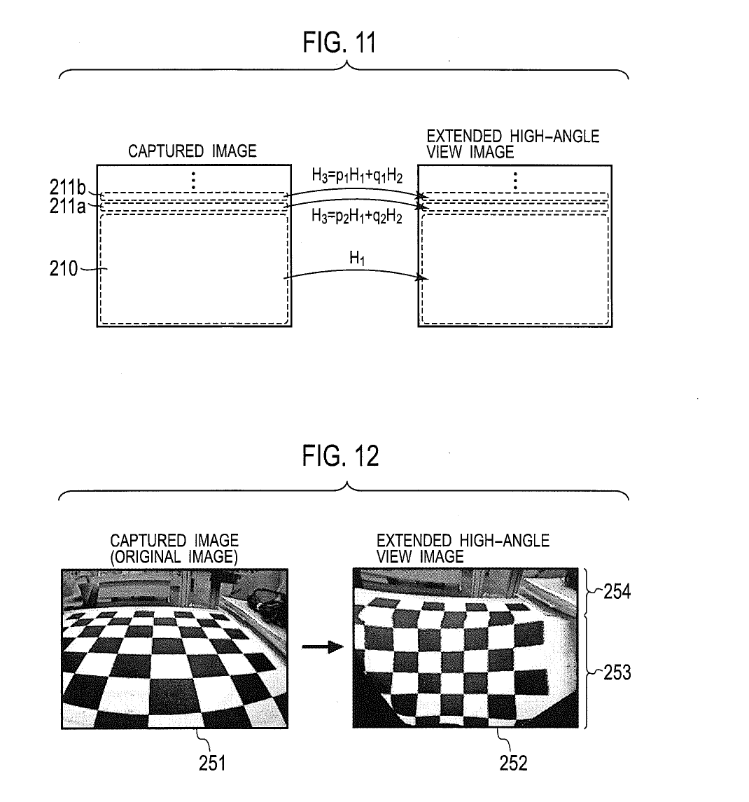

Once the conversion matrix corresponding to each pixel on the extended high-angle view image is determined, coordinate values of each pixel of the captured image corresponding to the coordinate values of each pixel of the extended high-angle view image also can be determined. Thus, it is possible to determine which conversion matrix to apply for which point on the captured image. For example, as shown in FIG. 11, it is determined such that H₁ is applied to the coordinate values of each pixel within the partial region 210 of the captured image; H₃=p₂H₁+q₂H₂ is applied to the coordinate values of each pixel within the partial region 211a of the captured image; and H₃=p₁H₁+q₁H₂ is applied to the coordinate values of each pixel within the partial region 211b of the captured image.

Once the conversion matrices to be applied to the coordinate values of each pixel of the captured image are determined, it becomes possible to convert any arbitrary captured image to the extended high-angle view image based on such conversion matrices. In practice, for example table data showing the corresponding relation between the coordinate values of each pixel of the captured image and the coordinate values of each pixel of the extended high-angle view image is prepared according to the conversion matrices determined as described above, and stored in a memory (look-up table) which is not shown. Then using this table data, the captured image is converted to the extended high-angle view image. Of course, the extended high-angle view image can also be generated by carrying out coordinate conversion operations based on H₁ and H₃ every time captured images are obtained at the camera 1.

FIG. 12 shows display examples of a captured image 251 and an extended high-angle view image 252 corresponding to the captured image 251. At the lower side of the extended high-angle view image 252, i.e. at the region 253 that is relatively close to the vehicle 100, a regular high-angle view image is displayed. By referring to this regular high-angle view image, a driver can easily gauge a distance between e.g. the vehicle 100 and an obstacle at the rear of the vehicle.

While it is difficult to display a region farther away from the vehicle when a common high-angle view conversion is used, with the extended high-angle view image, an image similar to the original image (captured image) rather than the high-angle view image is depicted in the upper side region 254. Thus, visibility of obstacles farther away from the vehicle also is supported. Moreover, by setting the weight-added conversion matrix H₃ as described above, the image within the region 253 and the image within the region 254 are put together seamlessly in the extended high-angle view image. Thus, it is possible to display the picture with excellent visibility. When a common high-angle view conversion is used, there is a problem that three-dimensional objects are largely deformed. However, such a problem also is improved with the extended high-angle view image.

Moreover, when the conventional perspective projection transformation was used, it became susceptible to installation errors of the camera. However, the method according to the embodiment uses the planar projective transformation, and thus, it is not susceptible (or less susceptible) to installation errors of the camera.

Next, a computation method for the second conversion matrix H₂ that can be used at the step S2 of FIG. 3 will be explained in detail. As a computation method for H₂, the first to the third computation methods will be illustrated as examples.

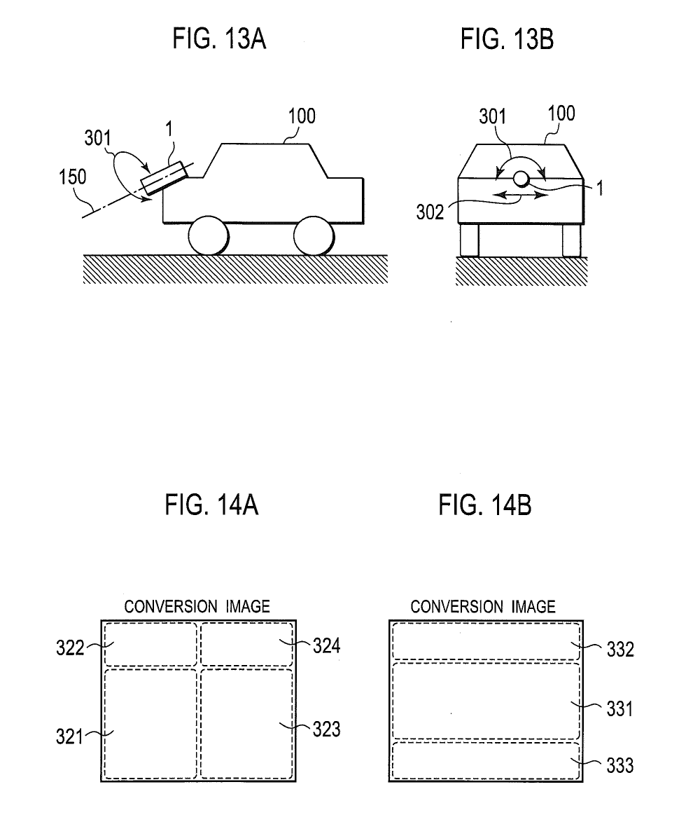

Before explaining each of the computation methods, mounting condition of the camera 1 relative to the vehicle 100 will be considered by referring to FIGS. 13A and 13B. FIG. 13A is a side view of the vehicle 100 and FIG. 13B is a back view of the vehicle 100. The camera 1 is installed at the rear end of the vehicle 100, but when the camera 1 is rotated around the light axis 150 of the camera 1 as a rotation axis, a still object in real space is rotated in the captured image. The reference number 301 indicates this rotational direction. Also, when the camera 1 is rotated on a plane including the light axis 150 (the rotational direction is shown by the reference number 302), a still object in real space moves in the horizontal direction on the captured image.

[First Computation Method]

First, the first computation method will be explained. The first computation method assumes that the camera 1 is rotated neither in the rotational direction 301 nor in the rotational direction 302, and thus is correctly (or generally correctly) oriented at the backward of the vehicle 100. It is also assumed that the image is not enlarged or reduced when generating the extended high-angle view image from the captured image.

Under such assumptions, the first computation method sets such that the second conversion matrix H₂ is indicated by the following formula (4). H₂ of the formula (4) is a non-conversion unit matrix. When the first computation method is adopted, the plane on which the captured image is projected by H₂ (which corresponds to the second plane 142 of FIG. 6) is a plane parallel to the imaging area of the camera 1 (or the imaging area itself).

$${H}_{2} = ( \begin{matrix}1 & 0 & 0 \\ 0 & 1 & 0 \\ 0 & 0 & 1\end{matrix} ) \qquad ( 4 )$$

[Second Computation Method]

Next, the second computation method will be explained. The second computation method assumes instances in which the camera 1 is rotated in the rotational direction 301 and there is a need to rotate the image when generating the extended high-angle view image from the captured image; the camera 1 is rotated in the rotational direction 302 and there is a need to horizontally move the image when generating the extended high-angle view image from the captured image; there is a need to enlarge or reduce the image when generating the extended high-angle view image from the captured image; or there is a need to perform the combination of the above. By adopting the second computation method, it is possible to respond to such instances. In other words, it is possible to respond to many installation conditions of the camera 1.

Under such assumptions, the second computation method sets such that the second conversion matrix H₂ is indicated by the following formula (5). R of the formula (5) is a matrix for rotating the image as shown in the formula (6a), and θ indicates the rotation angle. T of the formula (5) is a matrix for horizontally moving the image as shown in the formula (6b), and tₓ and t_{y} indicate the amount of displacement in the horizontal direction and in the vertical direction respectively. S is a matrix for enlarging or reducing the image, and a and b indicates the magnification percentage (or reduction percentage) of the image in the horizontal direction or in the vertical direction respectively.

$$\begin{matrix}{H}_{2} = RTS & ( 5 ) \\ R = ( \begin{matrix}cos θ & - sin θ & 0 \\ sin θ & cos θ & 0 \\ 0 & 0 & 1\end{matrix} ) & ( 6 a ) \\ T = ( \begin{matrix}1 & 0 & {t}_{x} \\ 0 & 1 & {t}_{y} \\ 0 & 0 & 1\end{matrix} ) & ( 6 b ) \\ S = ( \begin{matrix}a & 0 & 0 \\ 0 & b & 0 \\ 0 & 0 & 1\end{matrix} ) & ( 6 c )\end{matrix}$$

The matrices R, T, and S can be computed based on the captured image for calibration used when computing the first conversion matrix H₁ at the step S1 (see FIG. 3). That is, the matrices R, T, and S can be computed by using the coordinates (x_{A1}, y_{A1}), (x_{A2}, y_{A2}), (x_{A3}, y_{A3}), and (x_{A4}, y_{A4}) of the four feature points on the captured image for calibration identified at the step S1.

For example, by detecting inclination of a line connecting two of the four feature points on the captured image for calibration (such as feature points 123 and 124 of FIG. 4B), the matrix R is determined from such inclination. The image processing device 2 determines the value for the rotation angle θ based on the detected inclination while referring to known information indicating the positions of the two feature points in real space.

Also, for example the matrix T is determined from the coordinate values of the four feature points on the captured image for calibration. The matrix T can be determined if coordinates for at least one of the feature points are identified. The relation between the coordinates of the feature point in the horizontal and vertical directions and the values for the elements tₓ and t_{y} to be determined is previously established in light of characteristics of the calibration pattern 120.

Also, for example by detecting the number of pixels between two of the four feature points that are lined up in the horizontal direction of the image (such as the feature points 123 and 124 of FIG. 4B) on the captured image for calibration, the element a for the matrix S is determined from the number of pixels. The element b also can be similarly determined. The relation between the detected number of pixels and the values for the elements a and b to be determined is previously established in light of characteristics of the calibration pattern 120.

Moreover, the matrices R, T, and S also can be computed based on known parameters indicating installation conditions of the camera 1 relative to the vehicle 100 without utilizing the captured image for calibration.

[Third Computation Method]

Next, the third computation method will be explained. In the third calibration method, the second conversion matrix H₂ is computed by using the planar projective transformation in a similar way to the computation method for the first conversion matrix H₁. More specifically, it can be computed as described below.

The image obtained by coordinate conversion of the captured image for calibration by using the second conversion matrix H₂ will now be called a “second converted image for calibration” and coordinates of each point on the second converted image for calibration are indicated as (X_{B}, Y_{B}). Then, the relation between the coordinates (x_{A}, y_{A}) on the captured image for calibration and the coordinates (X_{B}, Y_{B}) on the second converted image for calibration can be indicated by the following formula (7) using the second conversion matrix H₂.

$$\begin{matrix}( \begin{matrix}{X}_{B} \\ {Y}_{B} \\ 1\end{matrix} ) = {H}_{2} ( \begin{matrix}{x}_{A} \\ {y}_{A} \\ 1\end{matrix} ) \\ = ( \begin{matrix}{h}_{B 1} & {h}_{B 2} & {h}_{B 3} \\ {h}_{B 4} & {h}_{B 5} & {h}_{B 6} \\ {h}_{B 7} & {h}_{B 8} & {h}_{B 9}\end{matrix} ) ( \begin{matrix}{x}_{A} \\ {y}_{A} \\ 1\end{matrix} ) \\ = ( \begin{matrix}{h}_{B 1} & {h}_{B 2} & {h}_{B 3} \\ {h}_{B 4} & {h}_{B 5} & {h}_{B 6} \\ {h}_{B 7} & {h}_{B 8} & 1\end{matrix} ) ( \begin{matrix}{x}_{A} \\ {y}_{A} \\ 1\end{matrix} )\end{matrix} \qquad ( 7 )$$

Then, coordinate values for the four feature points on the second converted image for calibration are determined based on known information previously recognized by the image processing device 2. The determined four coordinate values are indicated as (X_{B1}, Y_{B1}), (X_{B2}, Y_{B2}), (X_{B3}, Y_{B3}), and (X_{B4}, Y_{B4}). The coordinate values (X_{B1}, Y_{B1}) to (X_{B4}, Y_{B4}) are the coordinate values of when projecting the four feature points on the captured image for calibration on the second plane 142 rather than the first plane 141 (see FIG. 6). Then, similarly to when the first conversion matrix H₁ was computed, the elements h_{B1} to h_{B8} of H₂ can be computed based on the corresponding relations of the coordinate values of the four feature points between the captured image for calibration and the second converted image for calibration.

(Variants)

The specific numeric values shown in the explanation above are merely examples and they can be changed to various numeric values. Variants of the above described embodiments as well as explanatory notes will be explained below. The contents described below can be combined in any manner as long as they are not contradictory.

[Explanatory Note 1]

Although a method to perform the planar projective transformation was described above by using the calibration plate 120 on which a plurality of vertical and horizontal grid lines are formed as shown in FIGS. 4A and 4B, the invention is not limited to such examples. It is sufficient as long as an environment is put in place to enable the image processing device 2 to extract more than four feature points.

[Explanatory Note 2]

In the above embodiments, two projection planes composed of the first and second planes was assumed and the extended high-angle view image as a converted image was generated through derivation of two conversion matrices (H₁ and H₂). However, it is also possible to assume that there are more than three projection planes and to generate a converted image through derivation of more than three conversion matrices. As long as one of the more than three projection planes is the ground, such a converted image also can be called the extended high-angle view image.

For example, mutually different first to third planes are assumed as projection planes, and the first, second, and third conversion matrices are computed for projecting the captured image for calibration onto the first, second, and third planes. For example the first plane is the ground.

Then, for example as shown in FIG. 14A, the converted image is considered by segmenting the converted image into the four regions composed of the regions 321 to 324. The image within the region 321 is obtained by coordinate conversion of a first partial image within the captured image of the camera 1 by using the first conversion matrix. The image within the region 322 is obtained by coordinate conversion of a second partial image within the captured image of the camera 1 by using a weight-added conversion matrix obtained by weight-adding the first conversion matrix and the second conversion matrix. The image within the region 323 is obtained by coordinate conversion of a third partial image within the captured image of the camera 1 by using a weight-added conversion matrix obtained by weight-adding the first conversion matrix and the third conversion matrix. The image within the region 324 is obtained by coordinate conversion of a fourth partial image within the captured image of the camera 1 by using a weight-added conversion matrix obtained by weight-adding the first, second, and third conversion matrices. In this case, the captured image of the camera corresponds to an image in which the first to the fourth partial images are joined together.

In the example shown in FIG. 14A, the converted image is segmented into the four regions 321 to 324, but the method of segmenting the regions for the converted image can be changed in various ways. For example, the converted image can be segmented into three regions 331 to 333 as shown in FIG. 14B. The image within the region 331 is obtained by coordinate conversion of a first partial image within the captured image of the camera 1 by using the first conversion matrix. The image within the region 332 is obtained by coordinate conversion of a second partial image within the captured image of the camera 1 by using a weight-added conversion matrix obtained by weight-adding the first conversion matrix and the second conversion matrix. The image within the region 333 is obtained by coordinate conversion of a third partial image within the captured image of the camera 1 by using a weight-added conversion matrix obtained by weight-adding the first conversion matrix and the third conversion matrix. In this case, the captured image of the camera corresponds to an image in which the first to the third partial images are joined together.

In the instances that correspond to FIGS. 14A and 14B also, the weighting at the time of generating the weight-added conversion matrix can be gradually changed in accordance with the distance from the border between the adjacent regions in the converted image.

[Explanatory Note 3]

The above-described method also is applicable to a system that outputs wide range of video picture by synthesizing captured images of a plurality of cameras. For example, a system has been already developed in which one camera is installed at each of the front, rear and sides of a vehicle and the captured images of the total of four cameras are converted to a 360 degree high-angle view image by a geometric conversion to display it on a display unit (for example see Japanese Patent Application Laid-Open No. 2004-235986). The method of this invention also is applicable to such a system. The 360 degree high-angle view image corresponds to the high-angle view image in circumference of the vehicle periphery, and the image conversion utilizing the weight-addition of a plurality of conversion matrices can be adopted. In other words, an image conversion can be performed such that a normal high-angle view image is generated with respect to the image closer to the vehicle, whereas an image conversion is performed using the weight-added conversion matrix obtained by weight-adding a plurality of conversion matrices with respect to the image farther away from the vehicle.

In addition, this invention also is applicable to a system that generates and displays a panoramic image by synthesizing captured images of a plurality of cameras.

[Explanatory Note 4]

While the explanation was made for the embodiments by giving an example of the visibility support system that uses the camera 1 as an on-vehicle camera, it is also possible to install the camera connected to the image processing device 2 onto places other than a vehicle. That is, this invention is also applicable to a surveillance system such as in a building. In this type of the surveillance system also, a converted image such as the extended high-angle view image is generated from the captured image and such a converted image is displayed on the display device, similarly to the above-described embodiments.

[Explanatory Note 5]

The functions of the image processing device 2 of FIG. 2 can be performed by hardware, software or a combination thereof. All or a part of the functions enabled by the image processing device 2 may be written as a program and implemented on a computer.

[Explanatory Note 6]

For example, in the above-described embodiments, H₁ and H₂ function as the first and second conversion parameters respectively. The image processing device 2 of FIG. 2 includes the conversion image generating unit that generates the extended high-angle view image as the converted image from the captured image of the camera 1.

According to the present invention, it is possible to provide an image processor and an image processing method that achieves image processing that is less susceptible to camera installation errors while assuring a wide range of image depiction.

The invention may be embodied in other specific forms without departing from the spirit or essential characteristics thereof. The embodiments therefore are to be considered in all respects as illustrative and not restrictive; the scope of the invention being indicated by the appended claims rather than by the foregoing description, and all changes that come within the meaning and range of equivalency of the claims are therefore intended to be embraced therein.

What is claimed is:

1. An image processor, comprising:
a conversion image generating unit for generating a converted image from a captured image of a camera based on a plurality of conversion parameters including a first conversion parameter for projecting the captured image on a predetermined first plane and a second conversion parameter for projecting the captured image on a predetermined second plane, the second plane being different from the first plane,
wherein the converted image is generated by dividing the converted image into a plurality of regions including a first region and a second region, generating an image within the first region based on the first conversion parameter, and generating an image within the second region based on a weight-added conversion parameter obtained by weight-adding the first conversion parameter and the second conversion parameter.

2. The image processor according to claim 1, wherein an object closer to a camera installation position appears in an image within the first region, and an object farther away from the camera installation position appears in an image within the second region.

3. The image processor according to claim 1, wherein weight of the weight-addition corresponding to each point within the second region is set according to a distance from the border of the first region and the second region to the each point.

4. The image processor according to claim 3, wherein the weight is set such that a degree of contribution of the second conversion parameter to the weight-added conversion parameter is increased as the distance increases.

5. The image processor according to claim 1, wherein the camera is installed on a vehicle,
wherein the first plane is the ground on which the vehicle is placed, and
wherein the conversion image generating unit converts a part of the captured image of the camera to a high-angle view image viewed from a virtual observation point above the vehicle based on the first conversion parameter, and includes the high-angle view image as an image within the first region.

6. A vehicle, comprising:
a camera; and
an image processor that includes a conversion image generating unit for generating a converted image from a captured image of a camera based on a plurality of conversion parameters including a first conversion parameter for projecting the captured image on a predetermined first plane and a second conversion parameter for projecting the captured image on a predetermined second plane, the second plane being different from the first plane,
wherein the converted image is generated by dividing the converted image into a plurality of regions including a first region and a second region, and generating an image within the first region based on the first conversion parameter, and generating an image within the second region based on a weight-added conversion parameter obtained by weight-adding the first conversion parameter and the second conversion parameter.

7. The vehicle according to claim 6, wherein the converted image includes an object closer to the camera installation position in the image within the first region, and an object farther away from the camera installation position in the image within the second region.

8. The vehicle according to claim 6, wherein weight for the weight-addition corresponding to each point within the second region of the converted image is determined according to a distance from the boundary of the first region and the second region to each point.

9. The vehicle according to claim 8, wherein the weight is determined such that a degree of contribution by the second conversion parameter for the weight-added conversion parameter increases as the distance increases.

10. The vehicle according to claim 6, wherein the camera is installed on the vehicle,
wherein the first plane is the ground on which the vehicle is placed, and
wherein the conversion image generating unit converts a part of the captured image of the camera to a high-angle view image viewed from a virtual observation point above the vehicle based on the first conversion parameter, and includes the high-angle view image as an image within the first region.

11. An image processing method for generating a converted image from a captured image of a camera based on a plurality of conversion parameters including a first conversion parameter for projecting the captured image on a predetermined first plane and a second conversion parameter for projecting the captured image on a predetermined second plane, the second plane being different from the first plane, comprising:
dividing the converted image into a plurality of regions including a first region and a second region;
generating an image within the first region based on the first conversion parameter; and
generating an image within the second region based on a weight-added conversion parameter obtained by weight-adding the first conversion parameter and the second conversion parameter.

12. The image processing method according to claim 11, wherein an object closer to the camera installation position appears in the image within the first region, and an object farther away from the camera installation position appears in the image within the second region.

13. The image processing method according to claim 11, wherein weight of the weight-addition corresponding to each point within the second region is determined according to a distance from the boundary of the first region and the second region to each point.

14. The image processing method according to claim 13, wherein the weight is determined such that a degree of contribution by the second conversion parameter for the weight-added conversion parameter increases as the distance increases.

15. The image processing method according to claim 11, wherein the camera is installed on a vehicle,
wherein the first plane is the ground on which the vehicle is placed, and
wherein the generation of the conversion image includes converting a part of the captured image of the camera to a high-angle view image viewed from a virtual observation point above the vehicle based on the first conversion parameter, and including the high-angle view image as an image within the first region.
